(19) United States
(12) Patent Application Publication
(10) Pub. No.: US 2025/0384726 A1
(43) Pub. Date: Dec. 18, 2025

(54) WAREHOUSE ACCESS CONTROL SYSTEM AND METHOD OF OPERATING THE SAME

(71) Applicant: NANYA TECHNOLOGY CORPORATION, New Taipei City (TW)

(72) Inventors: Ying-Chuan WANG, New Taipei City (TW); Bing Xiong LIN, New Taipei City (TW); Li-Min JUNG, New Taipei City (TW)

(21) Appl. No.: 18/741,826

(22) Filed: Jun. 13, 2024

(51) Int. Cl. G07C 9/37; G08B 13/196

(52) U.S. Cl. CPC G07C 9/37; G08B 13/196

(57) ABSTRACT

The present disclosure provides a method of operating a warehouse access control system. The method includes: touring a plurality of images captured by a plurality of monitors; determining a biological feature of an unverified person and generating a determination result; switching a status of a warehouse based on the determination result; determining the status of the warehouse; detecting the images captured by the monitors; detecting whether there is any human in the images captured by the monitors; and issuing an alert if there is a human in at least one of the images captured by the monitors and the warehouse is under a warning status.

### BACKGROUND

### FIELD OF INVENTION

The present invention relates to a warehouse access control system and a method of operating the same.

### DESCRIPTION OF RELATED ART

A material warehouse will have access requirements for lift machines. Entrances and exits of the material warehouse are usually not equipped with hardware, such as three-claw gate, to gatekeeping the entrances and the exits. Therefore, once the warehouse gate is opened, even if facial recognition technology is configured to determine that a person is not an authorized person, the person cannot be blocked from entering or exiting. As mentioned above, there is currently no relevant solution or research.

Therefore, how to propose a warehouse access control system and a method of operating the same that can improve the security of the warehouse and prevent a suspicious person from stealing the property in the warehouse is one of the problems that the industry urgently wants to invest in research and development resources to solve.

### SUMMARY

In view of this, one purpose of the present disclosure is to provide a warehouse access control system and a method of operating the same can solve the aforementioned problems.

In order to achieve the above objective, according to an embodiment of the present disclosure, a method of operating a warehouse access control system includes: touring a plurality of images captured by a plurality of monitors; determining a biological feature of an unverified person and generating a determination result; switching a status of a warehouse based on the determination result; determining the status of the warehouse; detecting the images captured by the monitors; detecting whether there is any human in the images captured by the monitors; and issuing an alert if there is a human in at least one of the images captured by the monitors and the warehouse is under a warning status.

In one or more embodiments of the present disclosure, determining the biological feature of the unverified person and generating the determination result further includes: capturing an image of the unverified person; detecting the biological feature of the unverified person; and determining whether the biological feature of the unverified person conforms to a predetermined biological feature.

In one or more embodiments of the present disclosure, the biological feature includes a facial characteristic.

In one or more embodiments of the present disclosure, the predetermined biological feature is the biological feature of a gatekeeper.

In one or more embodiments of the present disclosure, the method of operating the warehouse access control system further includes determining whether an identity authentication device is triggered before capturing the image of the unverified person.

In one or more embodiments of the present disclosure, touring the images captured by the monitors is performed if the warehouse is under the warning status and if there is no human in the images captured by the monitors.

In one or more embodiments of the present disclosure, the method of operating the warehouse access control system further includes at least one of: recording a time of a latest image detected including the human if the warehouse is under an open status and if there is the human in at least one of the images captured by the monitors; and setting a time interval timing from the time of the latest image detected including the human.

In one or more embodiments of the present disclosure, the method of operating the warehouse access control system further includes determining whether detecting no human in the images captured by the monitors and exceeding a time interval if the warehouse is under an open status and if there is no human in the images captured by the monitors.

In one or more embodiments of the present disclosure, the method of operating the warehouse access control system further includes sending a reminder if detecting no human in the images captured by the monitors and exceeding the time interval.

In one or more embodiments of the present disclosure, touring the images captured by the monitors is performed if detecting no human in the images captured by the monitors without exceeding the time interval.

In order to achieve the above objective, according to an embodiment of the present disclosure, a warehouse access control system includes a plurality of monitors, an identify authentication device, a notification unit, a status display device, and a server. The monitors are configured to capture a plurality of images of a warehouse. The identity authentication device is connected to the monitors and is configured to capture an image of an unverified person. The notification unit is configured to send a reminder and issue an alert. The status display device is connected to the notification unit and is configured to display a first status light, a second status light different from the first status light, and a third status light different from the first status light and the second status light. The first status light indicates the warehouse is under an open status, the second status light indicates the warehouse is under a warning status, and the third status light indicates the warehouse is under an alert status. The server is electrically or communicatively connected to the monitors, the identity authentication device, the notification unit, and the status display device. The server is configured to tour the images captured by the monitors. The server is further configured to determine a biological feature of the unverified person and generate a determination result. The server is further configured to switch a status of the warehouse based on the determination result of the identity authentication device. The server is further configured to determine the status of the warehouse. The server is further configured to detect the images captured by the monitors. The server is further configured to detect whether there is any human in the images captured by the monitors. The server is further configured to control the notification unit to issue the alert if there is the human in at least one of the images captured by the monitors and the warehouse is under the warning status.

In one or more embodiments of the present disclosure, the server further includes a biological feature detection unit configured to detect the biological feature of the unverified person and a difference recognition unit configured to determine whether the biological feature of the unverified person conforms to a predetermined biological feature.

In one or more embodiments of the present disclosure, the biological feature includes a facial characteristic.

In one or more embodiments of the present disclosure, the predetermined biological feature is the biological feature of a gatekeeper.

In one or more embodiments of the present disclosure, the server is further configured to determine whether the identity authentication device is triggered before the identity authentication device captures an image of the unverified person.

In one or more embodiments of the present disclosure, the server tours the images captured by the monitors if the warehouse is under the warning status and if there is no human in the images captured by the monitors.

In one or more embodiments of the present disclosure, the server further includes a timing unit configured to perform at least one of: record a time of a latest image detected including the human if the warehouse is under the open status and if there is the human in at least one of the images captured by the monitors; and set a time interval timing from the time of the latest image detected including the human.

In one or more embodiments of the present disclosure, the server is configured to determine whether detecting no human in the images captured by the monitors and exceeding a time interval if the warehouse is under the open status and if there is no human in the images captured by the monitors.

In one or more embodiments of the present disclosure, the notification unit sends the reminder if the server detects no human in the images captured by the monitors and exceeds the time interval.

In one or more embodiments of the present disclosure, the server tours the images captured by the monitors is performed if detecting no human in the images captured by the monitors without exceeding the time interval.

In summary, in the warehouse access control system and the method of operating the same of the present disclosure, since the warehouse access control system includes the monitors configured to tour the images of the warehouse, the warehouse access control system can realtimely survey the warehouse in different views. In the warehouse access control system and the method of operating the same of the present disclosure, since the status of the warehouse is switched based on the determination result of the biological feature of the unverified person, and the predetermined biological feature is the biological feature of the gatekeeper, the security of the warehouse can be ensured by determining whether the verified person is the gatekeeper, thereby lowering costs of establishing a database of biological features of all employees and effectively improve the security of an open warehouse. In the warehouse access control system and the method of operating the same of the present disclosure, since the notification unit issue the alert if there is the human in at least one of the images captured by the monitors and the warehouse is under the warning status, the security of an open warehouse can be ensured without installing a gate having a movable fence or a three-claw gate. In the warehouse access control system and the method of operating the same of the present disclosure, since the notification unit sends the reminder if the server detects no human in the images captured by the monitors and exceeds the time interval, the warehouse access control system can remind the gatekeeper to be aware of the status of the warehouse, thereby preventing the gatekeeper from neglect of duty due to falling unconscious (e.g., falling asleep) or distraction temporarily. Overall, the warehouse access control system and the method of operating the same of the present disclosure not only improves the security of the warehouse and prevents a suspicious person from stealing the property in the warehouse.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a functional block diagram of a warehouse access control system in accordance with an embodiment of the present disclosure;

FIG. 2 is a flow chart of a method of operating the warehouse access control system in accordance with an embodiment of the present disclosure;

FIG. 3 is a flow chart of a method of operating the warehouse access control system in accordance with an embodiment of the present disclosure;

FIG. 4A is a schematic view of an identity authentication device in accordance with an embodiment of the present disclosure;

FIG. 4B is a schematic view of determining a biological feature of an unverified person by the identity authentication device in accordance with an embodiment of the present disclosure;

FIG. 5 is a schematic view of a status display device displaying a first status light or a second status light in accordance with an embodiment of the present disclosure;

FIG. 6A is a schematic view of the status display device displaying the second status light in accordance with an embodiment of the present disclosure;

FIG. 6B is a schematic view of a monitor capturing an image of a human existing in a warehouse in accordance with an embodiment of the present disclosure;

FIG. 7A is a schematic view of the status display device displaying the second status light or a third status light in accordance with an embodiment of the present disclosure;

FIG. 7B is a schematic view of an email sent in response to the third status light in accordance with an embodiment of the present disclosure;

FIG. 8 is a schematic view of the status display device displaying the first status light or the third status light in accordance with an embodiment of the present disclosure;

FIG. 9 is a schematic view of the status display device displaying the first status light in accordance with an embodiment of the present disclosure;

FIG. 10 is a schematic view of the monitor capturing a latest image of a human existing in the warehouse in accordance with an embodiment of the present disclosure; and

FIG. 11 is a schematic view of the monitor capturing a current image of no human existing in the warehouse in accordance with an embodiment of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature’s relationship to another element(s) or feature(s) as illustrated in the figures. The spatially relative terms are intended to encompass different orientations of the device in use or operation in addition to the orientation depicted in the figures. The system may be otherwise oriented (rotated 90 degrees or at other orientations) and the spatially relative descriptors used herein may likewise be interpreted accordingly.

As used herein, “around,” “about,” “approximately,” or “substantially” shall generally mean within 20 percent, or within 10 percent, or within 5 percent of a given value or range. Numerical quantities given herein are approximate, meaning that the term “around,” “about,” “approximately,” or “substantially” can be inferred if not expressly stated.

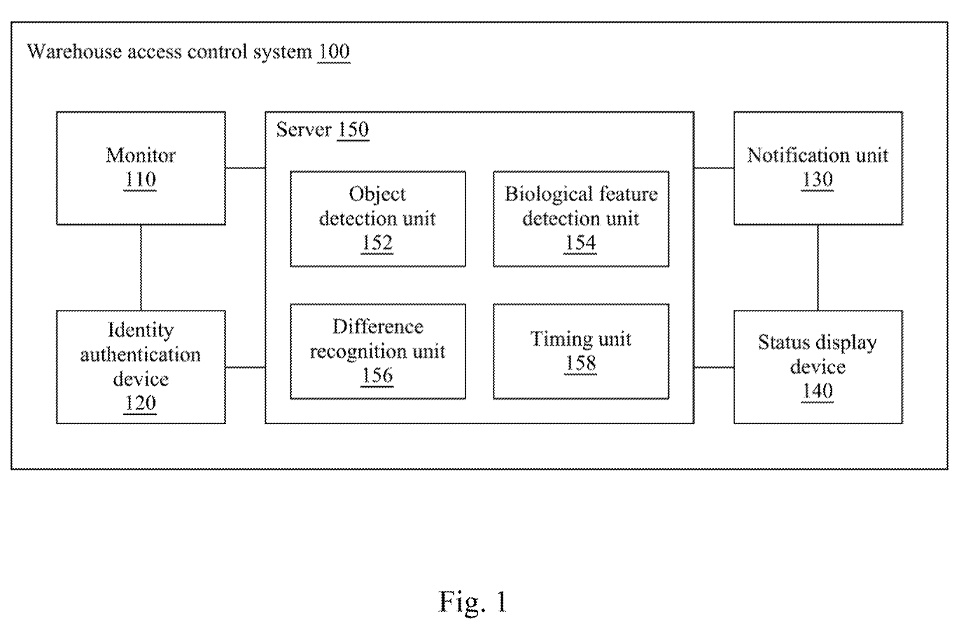

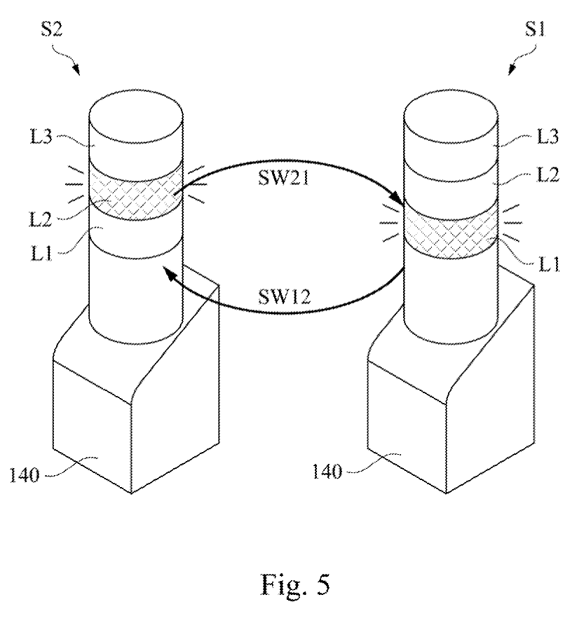

Reference is made to FIG. 1. FIG. 1 is a functional block diagram of a warehouse access control system 100 in accordance with an embodiment of the present disclosure. In this embodiment, the warehouse access control system 100 includes a plurality of monitors 110, an identity authentication device 120, a notification unit 130, a status display device 140, and a server 150. The monitors 110 are configured to capture a plurality of images of a warehouse W. The identity authentication device 120 is connected to the monitors 110. The identity authentication device 120 is configured to capture an image of an unverified person UP. The notification unit 130 is configured to send a reminder and issue an alert. The status display device 140 is connected to the notification unit 130. The status display device 140 is configured to display a first status light L1, a second status light L2 different from the first status light L1, and a third status light L3 different from the first status light L1 and the second status light L2, as shown in FIG. 5. The first status light L1 indicates the warehouse W is under an open status. The second status light L2 indicates the warehouse W is under a warning status. The third status light L3 indicates the warehouse W is under an alert status. The server 150 is electrically or communicatively connected to the monitors 110, the identity authentication device 120, the notification unit 130, and the status display device 140.

As shown in FIG. 1, the server 150 includes an object detection unit 152, a biological feature detection unit 154, a difference recognition unit 156, and a timing unit 158. The object detection unit 152 of the server 150 is configured to tour the images captured by the monitors 110. The biological feature detection unit 154 of the server 150 is further configured to determine a biological feature of the unverified person UP and generate a determination result. More specifically, the biological feature detection unit 154 is configured to detect the biological feature of the unverified person UP. In some embodiments, the server 150 is further configured to determine whether the identity authentication device 120 is triggered before the identity authentication device 120 captures the image of the unverified person UP. The difference recognition unit 156 is configured to determine whether the biological feature of the unverified person UP conforms to a predetermined biological feature. The server 150 is further configured to switch the status of the warehouse W based on the determination result of the identity authentication device 120. The server 150 is further configured to determine the status of the warehouse W. The object detection unit 152 of the server 150 is further configured to detect the images captured by the monitors 110. The object detection unit 152 of the server 150 is further configured to detect whether there is any human H in the images captured by the monitors 110. The server 150 is further configured to control the notification unit 130 to issue the alert if there is the human H in at least one of the images captured by the monitors 110 and the warehouse W is under the warning status. The timing unit 158 is configured to record a time of a latest image detected including the human if the warehouse W is under the open status and if there is the human H in at least one of the images captured by the monitors 110. The timing unit 158 is further configured to set a time interval timing from the time of the latest image detected including the human H. The difference recognition unit 156 is further configured to determine the difference between the image including the human H and the image exclusive of the human H.

In some embodiments, the monitors 110 may be webcam monitors, closed-circuit television (CCTV) monitors, digital television (DTV) monitors, or other suitable monitors. The present disclosure is not intended to limit the type of the monitors 110.

In some embodiments, the identity authentication device 120 may be facial recognition camera or other suitable identity authentication device. The present disclosure is not intended to limit the type of the identity authentication device 120.

In some embodiments, the alert may be issued by the notification unit 130 in a way of siren, email, phone call, push notification, a text message, or any suitable way or approach, or the combination thereof. The present disclosure is not intended to limit the type of the alert issued by the notification unit 130.

In some embodiments, the status display device 140 may be a lighting device, such as light emitting diode (LED), organic light emitting diode (OLED), quantum light emitting diode (QLED), traditional light bulb, or the like. In some embodiments, the status display device 140 may include a sounder, such as buzzer, siren, speaker, horn, or the like. In some embodiments, the status display device 140 may be a combination of the sounder and the lighting device. The present disclosure is not intended to limit the type of the status display device 140.

In some embodiments, the server 150 may be artificial intelligence (AI) module at least with the functions of deep learning, image recognition, object detection, or the like. The present disclosure is not intended to limit the type of the server 150.

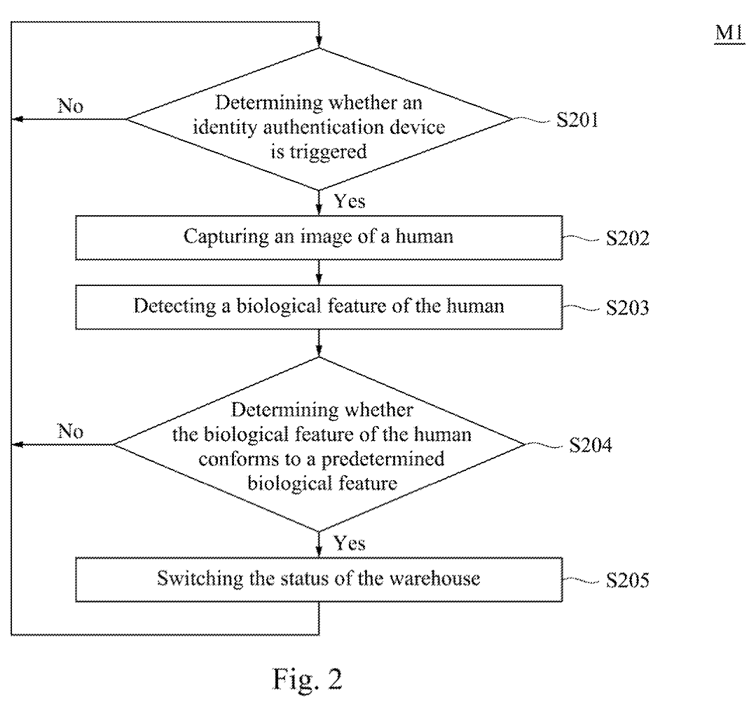

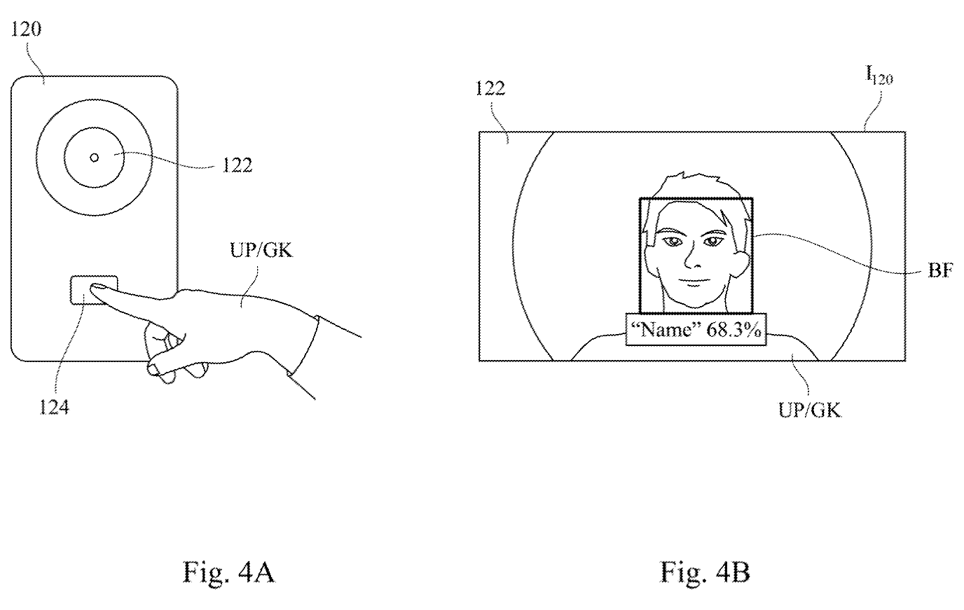

Reference is made to FIG. 2. FIG. 2 is a flow chart of a method M1 of operating the warehouse access control system 100 in accordance with an embodiment of the present disclosure. FIG. 2 shows a process of how to switch the status of the warehouse W by the identity authentication device 120 and the server 150. The method M1 shown in FIG. 2 includes a step S201, a step S202, a step S203, a step S204, and a step S205. Please refer to FIG. 2, FIG. 4A, FIG. 4B, and FIG. 5 for better understanding the step S201, the step S202, the step S203, the step S204, and the step S205.

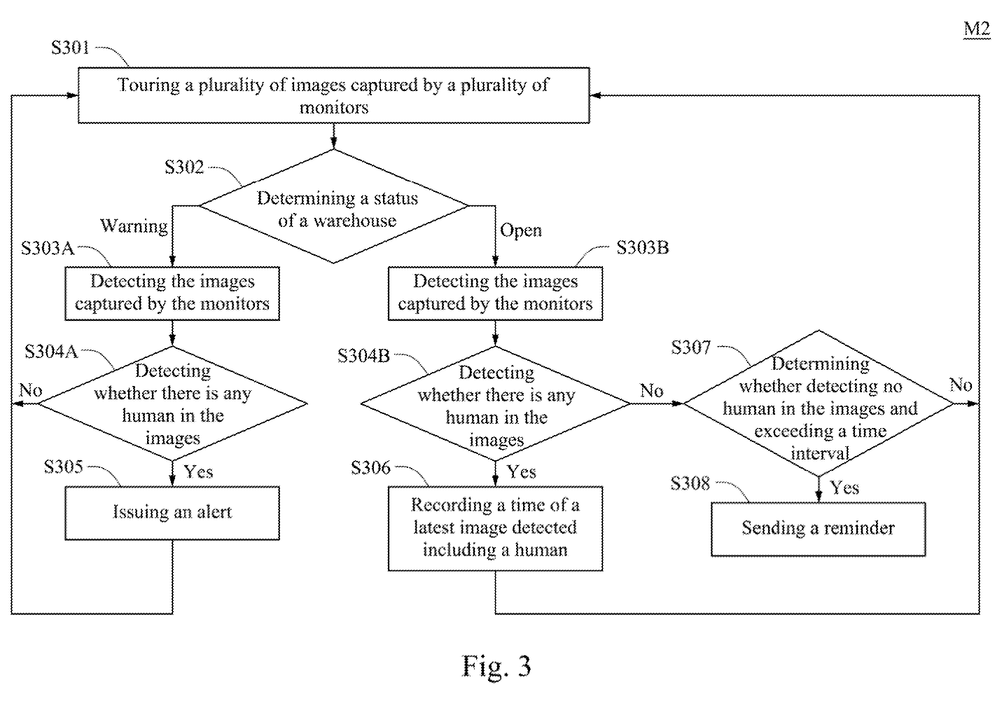

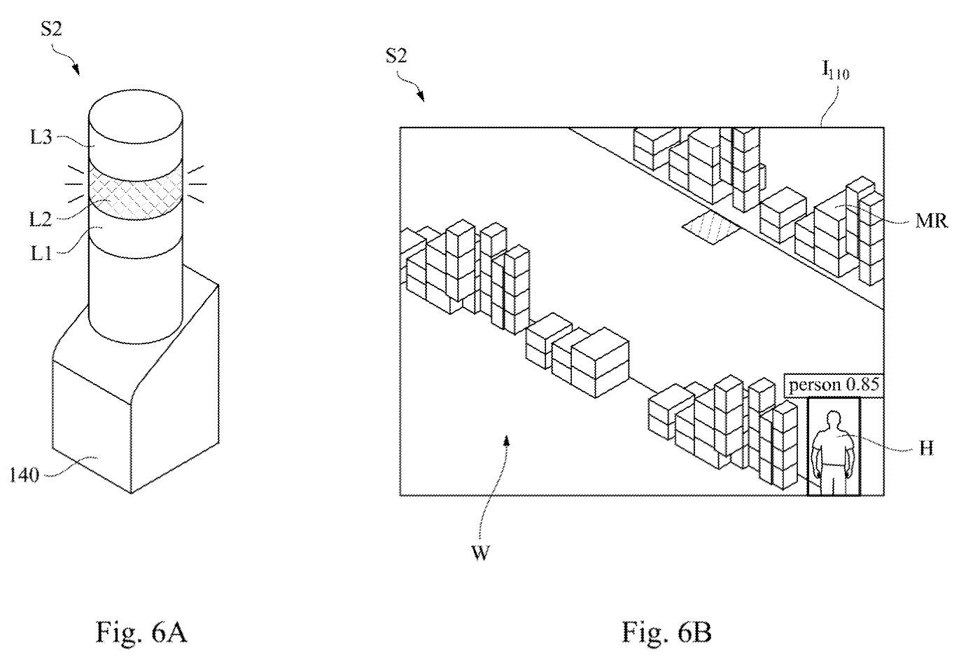

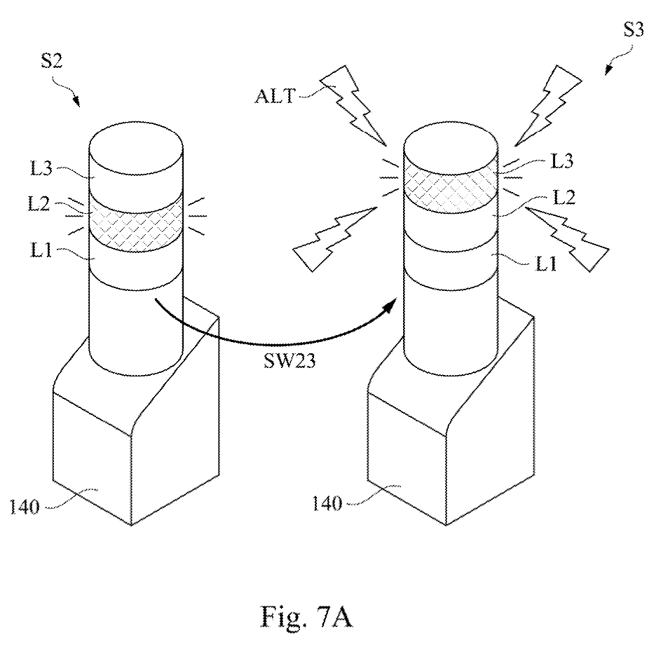

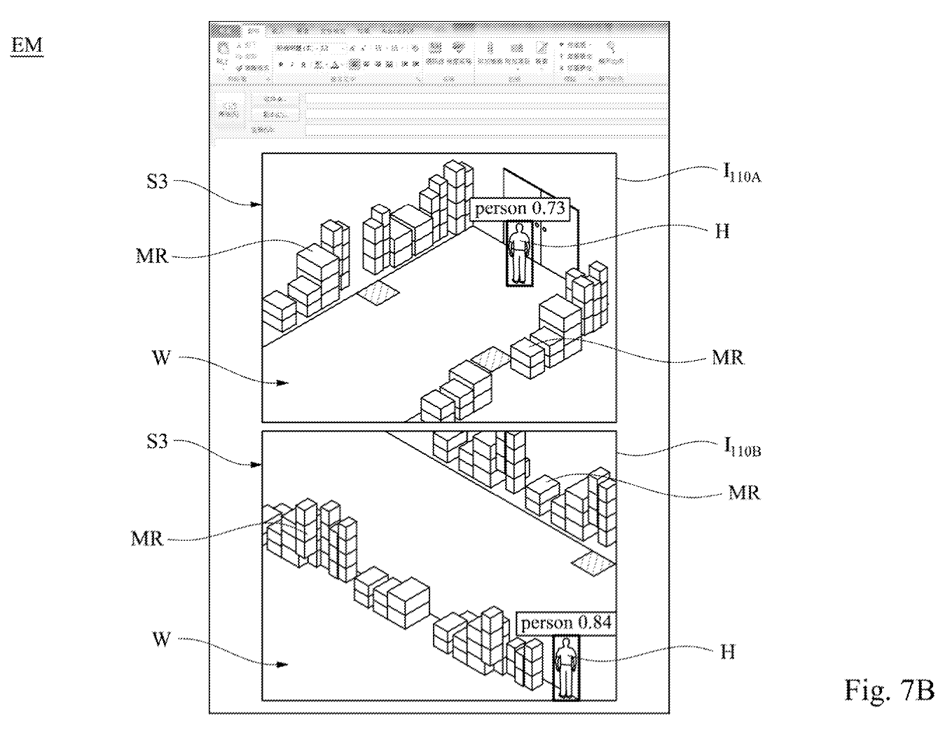

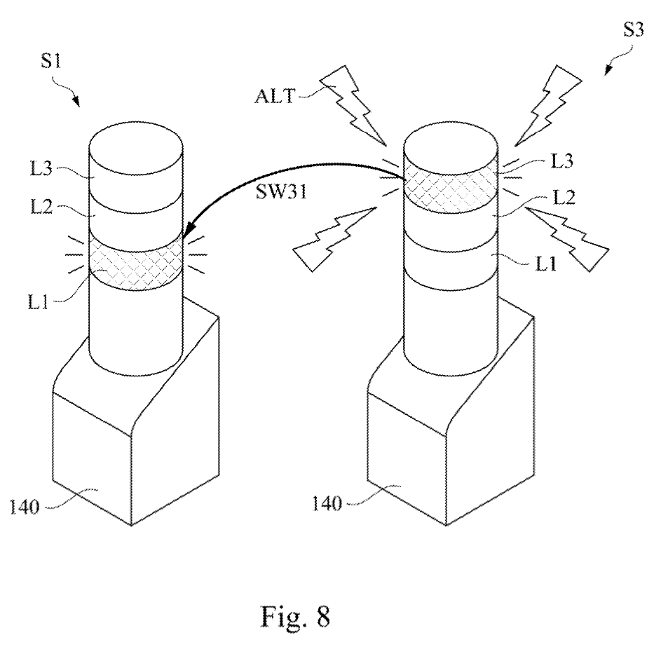

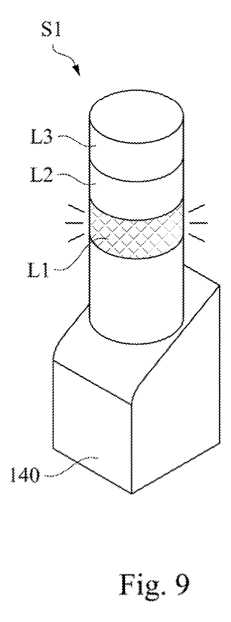

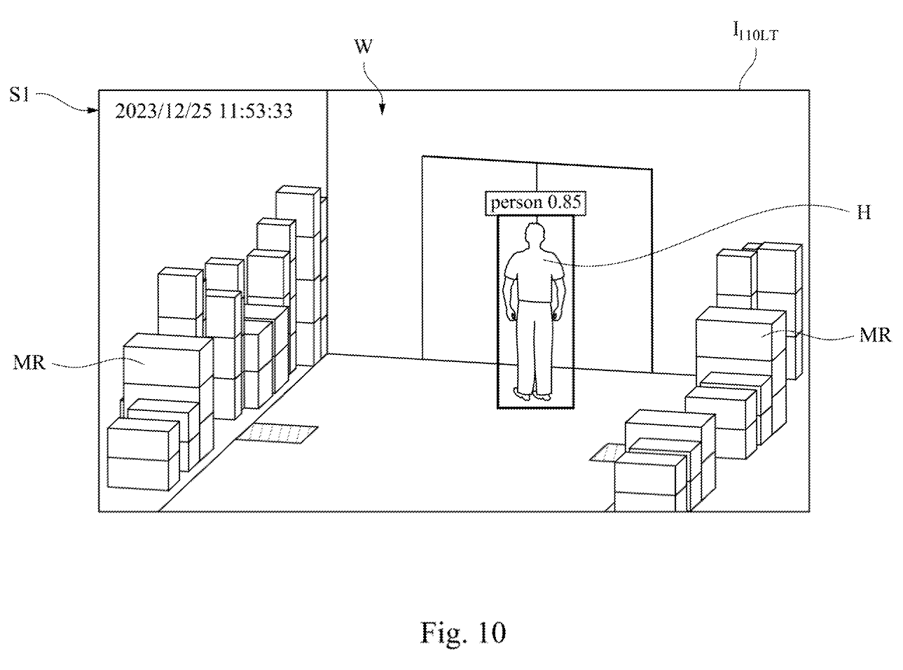

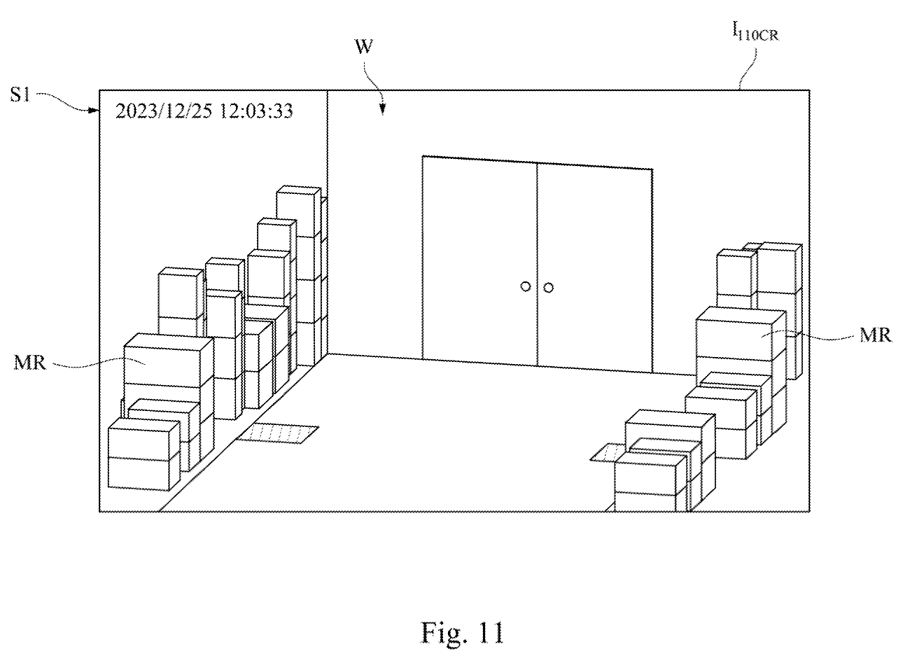

Reference is made to FIG. 3. FIG. 3 is a flow chart of a method M2 of operating the warehouse access control system 100 in accordance with an embodiment of the present disclosure. FIG. 3 shows a process of how to manage the access control of the warehouse W. The method M2 shown in FIG. 3 includes a step S301, a step S302, a stepS303A, a stepS303B, a step S304A, a step S304B, a step S305, a stepS306, a step S307, and a step S308. Please refer to FIG. 3, FIG. 5, FIG. 6A, FIG. 6B, FIG. 7A, FIG. 7B, FIG. 8, FIG. 9, FIG. 10, and FIG. 11 for better understanding the stepS301, the step S302, the stepS303A, the step S303B, the step S304A, the step S304B, the stepS305, the step S306, the step S307, and the stepS308.

StepS201, step S202, step S203, step S204, and step S205 are described in detail below.

Step S201: Determining whether the identity authentication device 120 is triggered.

Reference is made again to FIG. 4A and FIG. 4B. FIG. 4A is a schematic view of the identity authentication device 120 in accordance with an embodiment of the present disclosure. FIG. 4B is a schematic view of determining a biological feature BF of an unverified person UP by the identity authentication device 120 in accordance with an embodiment of the present disclosure. In this embodiment, the identity authentication device 120 includes an image capturing device 122 and a button 124. The image capturing device 122 is configured to capture an image of the unverified person UP. More specifically, the image capturing device 122 captures the image including the biological feature BF of the unverified person UP. The button 124 is configured to allow the unverified person UP to press, such that the identity authentication device 120 is triggered.

In a usage scenario, the unverified person UP presses the button 124. After the unverified person UP presses the button 124, the server 150 determine whether the identity authentication device 120 is triggered. The server 150 consistently determines whether the identity authentication device 120 is triggered.

In some embodiments, the biological feature BF of the unverified person UP includes a facial characteristic. In some other embodiments, the biological feature BF of the unverified person UP may include a fingerprint, a gesture, a pose, or other suitable biological feature.

Step S202: Capturing the image of a human.

Reference is made again to FIG. 4A and FIG. 4B. In this embodiment, if the server 150 determines the identity authentication device 120 is triggered, the image capturing device 122 of the identity authentication device 120 captures the image of the unverified person UP. In contrast, if the server 150 determines the identity authentication device 120 is not triggered, the image capturing device 122 of the identity authentication device 120 does not capture the image of the unverified person UP. More specifically, the server 150 determines whether the button 124 of the identity authentication device 120 is pressed while performing step S202.

In some embodiments, the step of determining whether the identity authentication device 120 is triggered (i.e., step S201) is performed before the step of capturing the image of the human (step S202).

In a usage scenario, if the server 150 determines the button 124 of the identity authentication device 120 is pressed, the server 150 therefore determines the identity authentication device 120 is triggered, so that the image capturing device 122 of the identity authentication device 120 captures the image of the unverified person UP. In contrast, if the server 150 determines the button 124 of the identity authentication device 120 is not pressed, the server 150 therefore determines the identity authentication device 120 is not triggered, so that the image capturing device 122 of the identity authentication device 120 does not capture the image of the unverified person UP. In this case, after the server 150 determines the identity authentication device 120 is not triggered, the server 150 continues to determine whether the identity authentication device 120 is triggered (i.e., step S201).

Step S203: Detecting the biological feature BF of the human.

Reference is made again to FIG. 4B. In this embodiment, after the image capturing device 122 of the identity authentication device 120 captures the image of the unverified person UP, the server 150 detects the biological feature BF of the unverified person UP. More specifically, the biological feature detection unit 154 of the server 150 detects the biological feature BF of the unverified person UP. As shown in FIG. 4B, an image I₁₂₀ is captured by the identity authentication device 120. A view of the image I₁₂₀ at least includes the biological feature BF of the unverified person UP. As shown in FIG. 4B, the biological feature detection unit 154 of the server 150 detects the biological feature BF of the unverified person UP in the view of the image I₁₂₀.

In some embodiments, the step of detecting the biological feature BF of the human (i.e., step S203) is performed after the step of capturing the image of the human (i.e., step S202).

In a usage scenario, if the image capturing device 122 of the identity authentication device 120 captured the image I₁₂₀, the biological feature detection unit 154 of the server 150 then detects the biological feature BF of the unverified person UP in the view of the image I₁₂₀.

Step S204: Determining whether the biological feature BF of the human conforms to a predetermined biological feature.

Reference is made to FIG. 4B. In this embodiment, after the biological feature detection unit 154 of the server 150 detects the biological feature BF of the unverified person UP, the server 150 determines whether the biological feature BF of the unverified person UP conforms to the predetermined biological feature. More specifically, the difference recognition unit 156 of the server 150 determines whether the biological feature BF of the unverified person UP conforms to the predetermined biological feature. In this embodiment, the biological feature detection unit 154 of the server 150 is further configured to generate a determination result. As shown in FIG. 4B, the determination result is generated by the difference recognition unit 156 of the server 150 calculating a similarity between the biological feature BF of the unverified person UP and the predetermined biological feature. In some embodiments, the predetermined biological feature is the facial characteristics of a gatekeeper GK. In other words, the gatekeeper GK is responsible for the access control of the warehouse W by authentication through the identity authentication device 120. If the similarity between the biological feature BF of the unverified person UP and the predetermined biological feature is determined to be greater than a threshold (e.g., 67%), the difference recognition unit 156 of the server 150 determines the biological feature BF of the unverified person UP does conform to the predetermined biological feature. In contrast, if the similarity between the biological feature BF of the unverified person UP and the predetermined biological feature is determined to be less than the threshold (e.g., 67%), the difference recognition unit 156 of the server 150 determines the biological feature BF of the unverified person UP does not conform to the predetermined biological feature. However, the present disclosure is not intended to limit the value of the threshold to be set.

In some embodiments, the step of determining whether the biological feature BF of the human conforms to the predetermined biological feature (i.e., step S204) is performed after the step of detecting the biological feature BF of the human (i.e., step S203).

In a usage scenario, if the biological feature detection unit 154 of the server 150 detected the biological feature BF of the unverified person UP in the view of the image I₁₂₀, the difference recognition unit 156 of the server 150 then determines whether the biological feature BF of the unverified person UP conforms to the predetermined biological feature. For instance, the difference recognition unit 156 of the server 150 calculates that the similarity between the biological feature BF of the unverified person UP and the predetermined biological feature is about 68.3%, which exceeds the threshold set to be 67%. Since the similarity between the biological feature BF of the unverified person UP and the predetermined biological feature is greater than the threshold, the difference recognition unit 156 of the server 150 determines the biological feature BF of the unverified person UP does conform to the predetermined biological feature. In other words, the difference recognition unit 156 of the server 150 determines the unverified person UP is substantially the gatekeeper GK of the warehouse W. In contrast, if the similarity between the biological feature BF of the unverified person UP and the predetermined biological feature is less than the threshold, the difference recognition unit 156 of the server 150 determines the biological feature BF of the unverified person UP does not conform to the predetermined biological feature. In other words, the difference recognition unit 156 of the server 150 determines the unverified person UP is not the gatekeeper GK of the warehouse W.

Step S205: Switching the status of the warehouse W.

Reference is made to FIG. 4B and FIG. 5. FIG. 5 is a schematic view of a status display device 140 displaying a first status light L1 or a second status light L2 in accordance with an embodiment of the present disclosure. In this embodiment, the server 150 switches the status of the warehouse W based on the determination result of the identity authentication device 120. If the server 150 determines the biological feature BF of the unverified person UP does conform to the predetermined biological feature, the server 150 switches the status of the warehouse W. In contrast, if the server 150 determines the biological feature BF of the unverified person UP does not conform to the predetermined biological feature, the server 150 does not switch the status of the warehouse W. More specifically, as shown in FIG. 5, the server 150 switches the status of the warehouse W by changing the status light of the status display device 140. In this embodiment, the server 150 performs an operation SW12 and an operation SW21. The operation SW12 is performed such that the warehouse W changes from a first status S1 to a second status S2 different from the first status S1. For instance, the warehouse W changes from the open status to the warning status. In addition, the operation SW12 is performed such that the status display device 140 changes its status light from the first status light L1 to the second status light L2. The operation SW21 is performed such that the warehouse W changes from the second status S2 to the first status S1. For instance, the warehouse W changes from the warning status to the open status. In addition, the operation SW21 is performed such that the status display device 140 changes its status light from the second status light L2 to the first status light L1.

In some embodiments, the step of switching the status of the warehouse W (i.e., step S205) is performed after the step of determining whether the biological feature BF of the human conforms to the predetermined biological feature (i.e., step S204).

In a usage scenario, if the server 150 determines the biological feature BF of the unverified person UP does conform to the predetermined biological feature, the server 150 therefore switches the status of the warehouse W, so that the server 150 performs the operation SW12 or the operation SW21 to change the status of the warehouse W. In contrast, if the server 150 determines the biological feature BF of the unverified person UP does not conform to the predetermined biological feature, the server 150 therefore do not switch the status of the warehouse W, so that the status of the warehouse W still remains. For instance, if the server 150 determines the biological feature BF of the unverified person UP does conform to the predetermined biological feature and the status display device 140 currently displays the first status light L1, the server 150 controls the status display device 140 to change its status light from the first status light L1 to the second status light L2. Or, if the server 150 determines the biological feature BF of the unverified person UP does conform to the predetermined biological feature and the status display device 140 currently displays the second status light L2, the server 150 controls the status display device 140 to change its status light from the second status light L2 to the first status light L1. In this case, after the server 150 determines the biological feature BF of the unverified person UP does not conform to the predetermined biological feature, the server 150 continues to determine whether the identity authentication device 120 is triggered (i.e., step S201).

By performing the method M1 shown in FIG. 2 of the present disclosure, the warehouse access control system 100 can switch the status of the warehouse W by determining whether the unverified person UP is the gatekeeper GK using the identity authentication device 120.

Step S301, step S302, step S303A, step S303B, step S304A, step S304B, step S305, step S306, step S307, and step S308 are described in detail below along with the introduction of several cases of the warehouse access control system 100.

Case 1: When the warehouse W is under the warning status, the alert will be immediately issued if the server 150 detects a human H in images captured by the monitors 110 in the warehouse W; if the alert is issued due to the gatekeeper GK forgetting performing the authentication, the gatekeeper GK can perform the authentication to terminate the alert.

Step S301: Touring a plurality of images captured by a plurality of monitors 110.

In the embodiment of the case 1, the monitors 110 of the warehouse access control system 100 are disposed in the warehouse W. The monitors 110 capture the images of the warehouse W in different viewing angles (as shown in FIG. 7B). The server 150 tours the images captured by the monitors 110. More specifically, the monitors 110 capture the real-time images of the warehouse W in different views, and the server 150 realtimely surveys the images of the warehouse W captured by the monitors 110.

Step S302: Determining the status of the warehouse W.

Reference is made to FIG. 6A. FIG. 6A is a schematic view of the status display device 140 displaying the second status light L2 in accordance with an embodiment of the present disclosure. In the embodiment of the case 1, the server 150 determines the status of the warehouse W. More specifically, the server 150 determines the warehouse W is under the first status S1 (i.e., the open status, in the second status S2 (i.e., the warning status), or in the third status S3 (i.e., the alert status). In the framework of the warehouse access control system 100, the first status S1 permits one or more persons to exist in the warehouse W. In some embodiments, the one or more persons at least include a user or the gatekeeper GK. For instance, the first status S1 permits the user pick up a material accompanied with the gatekeeper GK. The second S2 does not permit any person to exist in the warehouse W. For instance, neither the user nor the gatekeeper GK is allowed to exist in the warehouse W. In some embodiments, the server 150 determines the status of the warehouse W based on the status lights displayed by the status display device 140. For instance, if the status display device 140 displays the second status light L2, the server 150 determines the warehouse W is in the second status S2 (i.e., the warning status).

In a usage scenario, in the embodiment of the case 1, the status display device 140 displays the second status light L2, as shown in FIG. 6A. It should be noted that the operation of switching the status of the warehouse W may be performed by the method M1 shown in FIG. 2 as mentioned above. In the embodiment of the case 1, if the status display device 140 displays the second status light L2, the server 150 then determines that the warehouse W is under the warning state (i.e., the second state S2).

In some embodiments, the step of touring the images captured by the monitors 110 (i.e., step S301) is performed before the step of determining the status of the warehouse W (i.e., step S302). In some embodiments, the step of touring the images captured by the monitors 110 (i.e., step S301) is performed after the step of determining the status of the warehouse W (i.e., step S302). In some embodiments, the step of touring the images captured by the monitors 110 (i.e., step S301) and the step of determining the status of the warehouse W (i.e., step S302) are performed simultaneously.

Step S303A: Detecting the images captured by the monitors 110.

Reference is made to FIG. 6B. FIG. 6B is a schematic view of a monitor 110 capturing an image I₁₁₀ of a human H existing in the warehouse W in accordance with an embodiment of the present disclosure. In the embodiment of the case 1, the server 150 detects the images captured by the monitors 110. For instance, the object detection unit 152 of the server 150 detects objects showed in the images of the warehouse W. As shown in FIG. 7B, the object detection unit 152 of the server 150 detects the image I₁₁₀ captured by the monitors 110. In some embodiments, the object detection unit 152 of the server 150 detects there are the human H and a material MR in the image I₁₁₀. This represents there are the human H and a material MR in the warehouse W.

In some embodiments, the step of detecting the images captured by the monitors 110 (i.e., step S303A) is performed after the step of touring the images captured by the monitors 110 (i.e., step S301) or the step of determining the status of the warehouse W (i.e., step S302).

Step S304A: Detecting whether there is any human H in the images captured by the monitors 110.

In the embodiment of the case 1, the server 150 detects whether there is any human H in the warehouse W. More specifically, the object detection unit 152 of the server 150 detects whether there is any human H in the images captured by the monitors 110. In some embodiments, the object detection unit 152 of the server 150 detects at least the image I₁₁₀, an image I_{110A}, and an image I_{110B} (as shown in FIG. 7B). For instance, if the object detection unit 152 of the server 150 detected there is the human H in at least one of the image I₁₁₀, the image I_{110A}, and the image I_{110B}, the server 150 determines there is the human H in the warehouse W.

In a usage scenario, in the embodiment of the case 1, the object detection unit 152 of the server 150 detects whether there is any human H in the images captured by the monitors 110. As shown in FIG. 6B, if the object detection unit 152 of the server 150 detected there is the human H in the image I₁₁₀, the server 150 determines there is the human H in the warehouse W.

In some embodiments, the object detection unit 152 of the server 150 may be applied with object recognition technology, such as YOLOv8 or other suitable image recognition technology.

In some embodiments, the step of detecting whether there is any human H in the images captured by the monitors 110 (i.e., step S304A) is performed after the step of detecting the images captured by the monitors 110 (i.e., step S303A). In some embodiments, the step of detecting whether there is any human H in the images captured by the monitors 110 (i.e., step S304A) is performed after the step of touring the images captured by the monitors 110 (i.e., step S301) the step of determining the status of the warehouse W (i.e., step S302).

Step S305: Issuing an alert ALT.

Reference is made to FIG. 7A. FIG. 7A is a schematic view of the status display device 140 displaying the second status light L2 or a third status light L3 in accordance with an embodiment of the present disclosure. In the embodiment of the case 1, if the server 150 detects there is the human H in the images captured by the monitors 110 (as shown in FIG. 6B) and the warehouse W is under the warning status, the server 150 controls the notification unit to issue the alert ALT, as shown in FIG. 7A. In contrast, if the server 150 detects there is no human H in the images captured by the monitors 110, the notification unit 130 does not issue the alert ALT. More specifically, as shown in FIG. 7A, the server 150 switches the status of the warehouse W by changing the status light of the status display device 140. In this embodiment, the server 150 performs an operation SW23. The operation SW23 is performed such that the warehouse W changes from the second status S2 to the second status S3 different from the second status S2. For instance, the warehouse W changes from the warning status to the alert status. In addition, the operation SW23 is performed such that the status display device 140 changes its status light from the second status light L2 to the third status light L3. In this embodiment, if the status display device 140 displays the third status light L3, the alert ALT is sounded in response to the third status light L3.

Reference is made to FIG. 7B. FIG. 7B is a schematic view of an email EM sent in response to the third status light L3 in accordance with an embodiment of the present disclosure. In the embodiment of the case 1, if the status display device 140 displays the third status light L3, the email EM is sent in response to the third status light L3. In this embodiment, the alert ALT is issued by means of sending the email EM to members who has access to the warehouse W, as shown in FIG. 7B. In some embodiments, the members may include the gatekeeper GK and all members of a department related to the warehouse W. As shown in FIG. 7B, the content of the email EM may at least include the image I_{110A} and the image I_{110B}. In some embodiments, sounding the alert ALT and sending the email EM are performed simultaneously.

In some embodiments, the notification unit 130 may automatically make a phone call to a manager of the warehouse W when the gatekeeper GK is out of office hour. In some embodiments, the manager of the warehouse W may be substantially the gatekeeper GK. In some embodiments, sounding the alert ALT and making the phone call are performed simultaneously.

In some embodiments, the step of issuing an alert ALT (i.e., step S305) is performed after the step of detecting whether there is any human H in the images captured by the monitors 110 (i.e., step S304).

In a usage scenario, if the server 150 detects there is the human H in the images captured by the monitors 110, the server 150 therefore performs the operation SW23 to change the status of the warehouse W, so that the notification unit 130 issues the alert ALT. In contrast, if the server 150 detects there is no human H in the images captured by the monitors 110, the server 150 therefore do not perform the operation SW23, so that the status of the warehouse W still remains. For instance, if the server 150 detects there is the human H in the images captured by the monitors 110 and the status display device 140 currently displays the second status light L2, the server 150 controls the status display device 140 to change its status light from the second status light L2 to the third status light L3. In this case, after the server 150 detects there is no human H in the images captured by the monitors 110, the server 150 continues to tour the images captured by the monitors 110 (i.e., step S301).

Reference is made to FIG. 8. FIG. 8 is a schematic view of the status display device 140 displaying the first status light L1 or the third status light L3 in accordance with an embodiment of the present disclosure. In another embodiment of the case 1, if the server 150 controls the notification unit 130 to issue the alert ALT, the gatekeeper GK can terminate the alert by performing the method M1 shown in FIG. 2. In this embodiment, as shown in FIG. 8, the server 150 switches the status of the warehouse W by changing the status light of the status display device 140. In this embodiment, the server 150 performs an operation SW31. The operation SW31 is performed such that the warehouse W changes from the third status S3 to the first status S1 different from the third status S3. For instance, the warehouse W changes from the alert status to the open status. In addition, the operation SW31 is performed such that the status display device 140 changes its status light from the third status light L3 to the first status light L1. In this embodiment, if the status display device 140 changes its status light from the third status light L3 to the first status light L1, the alert ALT is terminated.

In a usage scenario, if the alert ALT is issued due to the gatekeeper GK forgetting performing the authentication while permitting the user to enter the warehouse W, the gatekeeper GK can perform the authentication to terminate the alert (e.g., performing the method M1 to change the status of the warehouse by the operation SW31).

Case 2: The gatekeeper GK lifts the warning status of the warehouse W to accompany a user to pick up a material MR from the warehouse W.

Step S301: Touring the images captured by the monitors 110.

In the embodiment of the case 2, the server 150 tours the images captured by the monitors 110. The details of the step S301 is discussed above, the step S301 will not repeatedly described herein.

Step S302: Determining the status of the warehouse W.

In the embodiment of the case 2, the server 150 determines the status of the warehouse W. The details of the step S302 is discussed above, the step S302 will not repeatedly described herein.

Reference is made to FIG. 9. FIG. 9 is a schematic view of the status display device 140 displaying the first status light L1 in accordance with an embodiment of the present disclosure. In a usage scenario, in the embodiment of the case 2, if the user is intended to take out the material MR from the warehouse W, the gatekeeper GK performs the method M1 as mentioned above. if the server 150 determines the biological feature BF of the unverified person UP does conform to the predetermined biological feature and the status display device 140 currently displays the second status light L2, the server 150 controls the status display device 140 to change its status light from the second status light L2 to the first status light L1 (i.e., step S205). Next, if the status display device 140 displays the first status light L1, the server 150 then determines that the warehouse W is under the open status (i.e., the first state S1). Because the warehouse W is under the open status, the gatekeeper GK is permitted to accompany the user to pick up the material MR from the warehouse W.

Case 3: Sending a reminder if the server 150 determines detecting no human H in the images captured by the monitors 110 and exceeding a time interval.

Step S303B: Detecting the images captured by the monitors 110.

Reference is made again to FIG. 6B. In the embodiment of the case 3, the server 150 detects the images captured by the monitors 110. Since the step S303B is almost similar to the step S303A, so the step S303B will not repeatedly described herein. The difference between the step S303B and the step S303A is that the step S303B is performed after the server 150 determines the warehouse W is under the open status (i.e., the first status S1).

In some embodiments, the step of detecting the images captured by the monitors 110 (i.e., step S303B) is performed after the step of touring the images captured by the monitors 110 (i.e., step S301) or the step of determining the status of the warehouse W (i.e., step S302).

Step S304B: Detecting whether there is any human H in the images captured by the monitors 110.

In the embodiment of the case 3, the server 150 detects whether there is any human H in the warehouse W. Since the step S304B is almost similar to the step S304A, so the step S304B will not repeatedly described herein. The difference between the step S304B and the step S304A is that the step S304B is performed after the server 150 determines the warehouse W is under the open status (i.e., the first status S1).

In some embodiments, the step of detecting whether there is any human H in the images captured by the monitors 110 (i.e., step S304B) is performed after the step of detecting the images captured by the monitors 110 (i.e., step S303A). In some embodiments, the step of detecting whether there is any human H in the images captured by the monitors 110 (i.e., step S304B) is performed after the step of touring the images captured by the monitors 110 (i.e., step S301) the step of determining the status of the warehouse W (i.e., step S302).

Step S306: Recording a time of a latest image detected including a human H.

Reference is made to FIG. 10 and FIG. 11. FIG. 10 is a schematic view of the monitors 110 capturing a latest image I_{110LT} of a human H existing in the warehouse W in accordance with an embodiment of the present disclosure. FIG. 11 is a schematic view of the monitors 110 capturing a current image I_{110CR} of no human H existing in the warehouse W in accordance with an embodiment of the present disclosure. In the embodiment of the case 3, the server 150 records the time of the latest image detected including the human H after the server 150 detected there is the human H in the images captured by the monitors 110. More specifically, the timing unit 158 of the server 150 records the time of the latest image detected including the human H. For instance, since the server 150 realtimely tours the images captured by the monitors 110, the difference recognition unit 156 may determine the difference between the image including the human H and the image exclusive of the human H at all time. In this embodiment, the timing unit 158 records the time just before the image detected no human H existing in the warehouse W.

In a usage scenario, after the status of the warehouse W is switched to the open status (i.e., the first status S1), the gatekeeper GK accompanies the user to take out the material MR from the warehouse W. As shown in FIG. 10, the object detection unit 152 of the server 150 detects there is the human H (e.g., the user or the gatekeeper GK) in the latest image I_{110LT}. A few moments later, as shown in FIG. 11, the human H is out of the view of the current image I_{110CR}. Next, the difference recognition unit 156 of the server 150 determines the difference between the latest image I_{110LT} and the current image I_{110CR}. In this embodiment, the latest image I_{110LT} and the current image I_{110CR} are adjacent images in a time sequence. If the difference recognition unit 156 of the server 150 determines the latest image I_{110LT} includes the human H and the current image I_{110CR} is exclusive of the human H, the timing unit 158 records the time of the latest image I_{110LT}.

In some embodiments, the step of recording the time of the latest image I_{110LT} detected including the human H (i.e., step S306) is performed after the step of detecting whether there is any human H in the images captured by the monitors 110 (i.e., step S304B).

Step S307: Determining whether detecting no human H in the images and exceeding a time interval.

In the embodiment of the case 3, if the object detection unit 152 of the server 150 detected there is no human H in the images captured by the monitors 110 (as shown in FIG. 11), the timing unit 158 of the server 150 determines whether detecting no human H in the images captured by the monitors 110 and exceeding the time interval. More specifically, the timing unit 158 of the server 150 determines the following: whether detecting no human H in the images captured by the monitors 110; and whether the time of the current image I_{110CR} detected no human H is later than the latest image I_{110LT} detected including the human H over the time interval.

In a usage scenario, after the status of the warehouse W is switched to the open status (i.e., the first status S1), the gatekeeper GK accompanies the user to take out the material MR from the warehouse W. As shown in FIG. 11, the human H is out of the view of the current image I_{110CR}. Next, the difference recognition unit 156 of the server 150 determines the difference between the latest image I_{110LT} and the current image I_{110CR}. If the difference recognition unit 156 of the server 150 determines the latest image I_{110LT} includes the human H and the current image I_{110CR} is exclusive of the human H, the timing unit 158 determining whether the server 150 detecting no human H in the images captured by the monitors 110 and whether the human H disappeared from the images captured by the monitors 110 exceeding the time interval.

In some embodiments, the time interval may be set to be about 10 minutes. However, the present disclosure is not intended to limit the time length of the time interval.

In some embodiments, the step of determining whether detecting no human H in the images and exceeding the time interval (i.e., step S307) is performed after the step of detecting whether there is any human H in the images captured by the monitors 110 (i.e., step S304B).

Step S308: Sending a reminder.

In the embodiment of the case 3, if the timing unit 158 of the server 150 determines there is no human H in the images captured by the monitors 110 and the human H disappeared from the images captured by the monitors 110 exceeding the time interval, the notification unit 130 sends the reminder. More specifically, the notification unit 130 sends the reminder to the manager of the warehouse W. In some embodiments, the manager of the warehouse W may be substantially the gatekeeper GK. In the embodiment of the case 3, the notification unit 130 sends the reminder by means of sending the email EM to the manager of the warehouse W (e.g., the gatekeeper GK). The email EM reminds the gatekeeper GK to re-confirms the status of the warehouse W.

In a usage scenario, if the gatekeeper GK forgets to switch the status of the warehouse W after the user finish the picking up the material MR, the notification unit 130 will send the reminder to the gatekeeper GK if the user left the warehouse W exceeding the time interval (e.g., over 10 minutes).

In another embodiment of the case 3, if the warehouse W is still under the open state (i.e., the first status S1) after a closing time (e.g., 5 p.m.), the notification unit 130 sends the reminder to the manager of the warehouse W. In a usage scenario, if the gatekeeper GK forgets to switch the status of the warehouse W after the closing time (e.g., 5 p.m.), the notification unit 130 will send the reminder to the gatekeeper GK.

In some embodiments, the step of sending the reminder (i.e., step S308) is performed after the step of determining whether detecting no human H in the images captured by the monitors 110 and exceeding the time interval (i.e., step S307).

By performing the method M1 shown in FIG. 2 and the method M2 shown in FIG. 3 of the present disclosure, the access control of the warehouse W may be well ensured.

Based on the above discussions, it can be seen that in the warehouse access control system and the method of operating the same of the present disclosure, since the warehouse access control system includes the monitors configured to tour the images of the warehouse, the warehouse access control system can realtimely survey the warehouse in different views. In the warehouse access control system and the method of operating the same of the present disclosure, since the status of the warehouse is switched based on the determination result of the biological feature of the unverified person, and the predetermined biological feature is the biological feature of the gatekeeper, the security of the warehouse can be ensured by determining whether the verified person is the gatekeeper, thereby lowering costs of establishing a database of biological features of all employees and effectively improve the security of an open warehouse. In the warehouse access control system and the method of operating the same of the present disclosure, since the notification unit issue the alert if there is the human in at least one of the images captured by the monitors and the warehouse is under the warning status, the security of an open warehouse can be ensured without installing a gate having a movable fence or a three-claw gate. In the warehouse access control system and the method of operating the same of the present disclosure, since the notification unit sends the reminder if the server detects no human in the images captured by the monitors and exceeds the time interval, the warehouse access control system can remind the gatekeeper to be aware of the status of the warehouse, thereby preventing the gatekeeper from neglect of duty due to falling unconscious (e.g., falling asleep) or distraction temporarily. Overall, the warehouse access control system and the method of operating the same of the present disclosure not only improves the security of the warehouse and prevents a suspicious person from stealing the property in the warehouse.

In some embodiments, the warehouse access control system 100 of the present disclosure can be applied in artificial intelligence (AI) computing and edge computing.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A method of operating a warehouse access control system, comprising:
touring a plurality of images captured by a plurality of monitors;
determining a biological feature of an unverified person and generating a determination result;
switching a status of a warehouse based on the determination result;
determining the status of the warehouse;
detecting the images captured by the monitors;
detecting whether there is any human in the images captured by the monitors; and
issuing an alert if there is a human in at least one of the images captured by the monitors and the warehouse is under a warning status.

2. The method of claim 1, wherein determining the biological feature of the unverified person and generating the determination result further comprises:
capturing an image of the unverified person;
detecting the biological feature of the unverified person; and
determining whether the biological feature of the unverified person conforms to a predetermined biological feature.

3. The method of claim 2, wherein the biological feature comprises a facial characteristic.

4. The method of claim 2, wherein the predetermined biological feature is the biological feature of a gatekeeper.

5. The method of claim 2, further comprising determining whether an identity authentication device is triggered before capturing the image of the unverified person.

6. The method of claim 1, wherein touring the images captured by the monitors is performed if the warehouse is under the warning status and if there is no human in the images captured by the monitors.

7. The method of claim 1, further comprising at least one of:
recording a time of a latest image detected including the human if the warehouse is under an open status and if there is the human in at least one of the images captured by the monitors; and
setting a time interval timing from the time of the latest image detected including the human.

8. The method of claim 1, further comprising determining whether detecting no human in the images captured by the monitors and exceeding a time interval if the warehouse is under an open status and if there is no human in the images captured by the monitors.

9. The method of claim 8, further comprising sending a reminder if detecting no human in the images captured by the monitors and exceeding the time interval.

10. The method of claim 8, wherein touring the images captured by the monitors is performed if detecting no human in the images captured by the monitors without exceeding the time interval.

11. A warehouse access control system, comprising:
a plurality of monitors configured to capture a plurality of images of a warehouse;
an identity authentication device connected to the monitors and configured to capture an image of an unverified person;
a notification unit configured to send a reminder and issuing an alert;
a status display device connected to the notification unit and configured to display a first status light, a second status light different from the first status light, and a third status light different from the first status light and the second status light, wherein the first status light indicates the warehouse is under an open status, the second status light indicates the warehouse is under a warning status, and the third status light indicates the warehouse is under an alert status; and
a server electrically or communicatively connected to the monitors, the identity authentication device, the notification unit, and the status display device, wherein the server is configured to:
tour the images captured by the monitors;
determine a biological feature of the unverified person and generate a determination result;
switch a status of the warehouse based on the determination result of the identity authentication device;
determine the status of the warehouse;
detect the images captured by the monitors;
detect whether there is any human in the images captured by the monitors; and
control the notification unit to issue the alert if there is the human in at least one of the images captured by the monitors and the warehouse is under the warning status.

12. The warehouse access control system of claim 11, wherein the server further comprises a biological feature detection unit configured to detect the biological feature of the unverified person and a difference recognition unit configured to determine whether the biological feature of the unverified person conforms to a predetermined biological feature.

13. The warehouse access control system of claim 12, wherein the biological feature comprises a facial characteristic.

14. The warehouse access control system of claim 12, wherein the predetermined biological feature is the biological feature of a gatekeeper.

15. The warehouse access control system of claim 11, wherein the server is further configured to:
determine whether the identity authentication device is triggered before the identity authentication device captures an image of the unverified person.

16. The warehouse access control system of claim 11, wherein the server tours the images captured by the monitors if the warehouse is under the warning status and if there is no human in the images captured by the monitors.

17. The warehouse access control system of claim 11, wherein the server further comprises a timing unit configured to perform at least one of:
record a time of a latest image detected including the human if the warehouse is under the open status and if there is the human in at least one of the images captured by the monitors; and
set a time interval timing from the time of the latest image detected including the human.

18. The warehouse access control system of claim 11, wherein the server is configured to:
determine whether detecting no human in the images captured by the monitors and exceeding a time interval if the warehouse is under the open status and if there is no human in the images captured by the monitors.

19. The warehouse access control system of claim 18, wherein the notification unit sends the reminder if the server detects no human in the images captured by the monitors and exceeds the time interval.

20. The warehouse access control system of claim 18, wherein the server tours the images captured by the monitors is performed if detecting no human in the images captured by the monitors without exceeding the time interval.
